(19) United States
(12) Patent Application Publication
(10) Pub. No.: US 2023/0005160 A1
(43) Pub. Date: Jan. 5, 2023

(54) MULTI-TASK DEEP LEARNING-BASED REAL-TIME MATTING METHOD FOR NON-GREEN-SCREEN PORTRAITS

(71) Applicant: COMMUNICATION UNIVERSITY OF ZHEJIANG, HANGZHOU CITY (CN)

(72) Inventors: Dingguo YU, Hangzhou City (CN); Qiang LIN, Hangzhou (CN); Xiaoyu MA, Hangzhou City (CN)

(21) Appl. No.: 17/725,292

(22) Filed: Apr. 20, 2022

(30) Foreign Application Priority Data
Jul. 2, 2021 (CN) 202110748585.5

(51) Int. Cl. G06T 7/194; G06V 10/40; G06V 10/25; G06T 3/40; G06N 3/08

(52) U.S. Cl. CPC G06T 7/194; G06V 10/40; G06V 10/25; G06T 3/40; G06N 3/08; G06T 2207/20081; G06T 2207/20084

(57) ABSTRACT

A multi-task deep learning-based real-time matting method for non-green-screen portraits is provided. The method includes: performing binary classification adjustment on an original dataset, inputting an image or video containing portrait information, and performing preprocessing; constructing a deep learning network for person detection, extracting image features by using a deep residual neural network, and obtaining a region of interest (ROI) of portrait foreground and a portrait trimap in the ROI through logistic regression; and constructing a portrait alpha mask matting deep learning network. An encoder sharing mechanism effectively accelerates a computing process of the network. An alpha mask prediction result of the portrait foreground is output in an end-to-end manner to implement portrait matting. In this method, green screens are not required during portrait matting. In addition, during the matting, only original images or videos need to be provided, without a need to provide manually annotated portrait trimaps.

### CROSS REFERENCE TO RELATED APPLICATIONS

This patent application claims the benefit of and priority to Chinese Patent Application No. 202110748585.5, filed on Jul. 2, 2021, the disclosure of which is incorporated herein by reference in its entirety.

### TECHNICAL FIELD

The present disclosure relates to the technical fields of deep learning, object detection, automatic trimap generation, and alpha mask matting of portrait foreground, and specifically, to a multi-task deep learning-based real-time matting method for non-green-screen portraits.

### BACKGROUND ART

In recent years, due to the rapid development of the Internet information age, human daily life is ubiquitously flooded with a large amount of digital content. Among the large amount of digital content, digital image information, including images and videos, has gradually become an important carrier of information dissemination by virtue of its intuitiveness, understandability, and rich and diverse content forms. The progress of the times has spawned many Internet content production organizations and even individual creators. However, editing and processing of the digital image information are complex and difficult. There are specific requirements for related industries, and practitioners need to spend a lot of effort and time on content creation. Therefore, people's demand for efficient and easy-to-access content production methods becomes increasingly urgent. A digital image matting technology is one of key researches on digital image information editing and processing technologies.

The digital image matting technology mainly aims to separate foreground and background of an image or video, to implement high-accuracy foreground extraction and virtual background replacement. As a main application field of digital image matting, portrait matting came into being with production needs of the film industry as early as the middle of the twentieth century. A portrait matting technology is used to implement early film special effects by extracting a foreground actor and combining the foreground actor with virtual scene background. After decades of industrial technology development, film and television special effects integrated with digital image matting can reduce content production costs and ensure the safety of actors, and also bring exciting viewing experience to audiences. The portrait matting technology has become an irreplaceable part of film and television program production.

In early researches, the digital portrait matting technology requires users to provide prior background knowledge. In traditional film and television production, a solid green or blue screen with a large difference in color from person skin and clothing is usually used as background at a shooting site. Pixels of a subject and the background are compared to implement portrait matting. However, professional green screen background requires a high level of erection, and lighting conditions of the site are strictly limited. It is difficult for general users to use a green screen technology at low costs. As the digital age rapidly develops, public's demand for the digital portrait matting technology has been more widely extended to scenes such as image editing and network meetings to meet their needs for entertainment, privacy protection, and the like. After decades of development, researches of the digital portrait matting technology have also made remarkable achievements. However, existing algorithms mainly have three shortcomings. First, in some researches, manually annotated portrait trimaps need to be provided, and construction of the trimaps requires a lot of labor and time. Secondly, most of research algorithms take a long time, and a small quantity of frames per second cannot implement real-time portrait matting. Finally, for an existing portrait matting algorithm featuring fast computing, a scene image that contains a subject and a scene image that does not contain the subject under the same background usually need to be provided. This limits usage scenes of the algorithm.

### SUMMARY

In view of the shortcomings in the prior art and the technical problems of digital image matting, the present disclosure provides a multi-task deep learning-based real-time matting method for non-green-screen portraits.

The present disclosure provides a multi-task deep learning-based real-time matting method for non-green-screen portraits. Focusing on key technologies such as person detection, trimap generation, and portrait alpha mask matting during portrait matting in complex natural environments, the present disclosure implements requirement-free, real-time, and automatic portrait matting when professional green screen devices are lacked. The present disclosure can be applied to application programs such as network meetings and photography editing to provide convenient digital portrait matting services for general users.

The objectives of the present disclosure are achieved by the following technical solutions:

A multi-task deep learning-based real-time matting method for non-green-screen portraits includes the following steps:

step 1: performing binary classification adjustment on an original multi-class multi-object detection dataset, inputting an image or video file in an adjusted dataset (that is, inputting an image or video containing portrait information), and performing corresponding data preprocessing on the image or video to obtain preprocessed data of the original input file;

step 2: using an encoder-logistic regression structure to construct a deep learning network for person detection, inputting the preprocessed data obtained in step 1, constructing a loss function, training and optimizing the deep learning network for person detection to obtain a person detection model;

step 3: extracting feature maps from an encoder of the person detection model in step 2, and performing feature stitching and fusing multi-scale image features to form an encoder of a portrait alpha mask matting network, to implement an encoder shared by the person detection and portrait alpha mask matting networks;

step 4: constructing a decoder of the portrait alpha mask matting network, forming an end-to-end encoder-decoder portrait alpha mask matting network structure together with the shared encoder in step 3, inputting an image containing person information and a trimap, constructing a loss function, and training and optimizing the portrait alpha mask matting network;

step 5: inputting the preprocessed data obtained in step 1 to a trained network in step 4, and outputting a region of interest (ROI) of portrait foreground and a portrait trimap in the ROI through logistic regression of the person detection model in step 2; and

step 6: inputting the ROI of the portrait foreground and the portrait trimap in step 5 into the portrait alpha mask matting network constructed in step 4 to obtain a portrait alpha mask prediction result.

In step 1, the binary classification adjustment is performed to modify the original 80-class common objects in context (COCO) dataset to two classes: person and others, and the dataset is supplemented according to this criterion. A task of detecting other classes of objects is abandoned to improve accuracy of subsequent person detection by the network model.

In step 1, the data preprocessing may include video frame processing and input image resizing.

The video frame processing may include:

Convert the video into video frames by using FFmpeg such that a processed video file can be processed by using a same method as that used to process an image file in subsequent work. Specifically, convert the video into video frames by using FFmpeg, use an original video number as a folder name in a project directory, and store the frames as image files in the folder.

The input image resizing may include:

Resize the input images by unifying sizes of different input images through cropping and padding and keep sizes of network feature maps the same as those of the original images. Specifically, unify sizes of different input images. Calculate a zoom factor with a longest side of an original image as a reference side, compress the longest side in equal proportions to an input criterion specified by the subsequent network, and fill vacant content on a short side of the image with gray background.

In step 2, the preprocessed data obtained in step 1 is input, an error of the ROI, a confidence level error of the ROI, and a person binary classification cross-entropy error are used to construct the loss function, and the person detection network (namely, the deep learning network for person detection) is trained and optimized.

The deep learning network for person detection is implemented through model prediction of a deep residual neural network.

The deep residual neural network includes an encoder and logistic regression.

The encoder is a fully convolutional residual neural network. In the network, skip connections are used to construct residual blocks res_block of different depths and a feature sequence X is obtained by extracting features of the image containing the portrait information. For a processed frame {Vₜ}ₜ₌₁^{T} in step 1, a feature sequence {xₜ}ₜ₌₁^{T′} of a length T is extracted. Vₜ represents a t^{th} frame, and xₜ represents a feature sequence of the t^{th} frame.

The feature extraction may include:

Use a deep learning technology to perform a cognitive process of the original image or the frame obtained after the video is preprocessed, and convert the image into a feature sequence that can be recognized by a computer.

The logistic regression is an output structure for multi-scale detection of a central position (xᵢ, yᵢ) of a ROI, a length and width (wᵢ, hᵢ) of the ROI, a confidence level Cᵢ of the ROI, a class pᵢ(c), c∈classes of an object in the ROI, and the person foreground f(pixelᵢ) and background b(pixelᵢ) binary classification results. classes represents all classes in the training sample, and pixelᵢ represents an i^{th} pixel in the ROI.

In step 3, large, medium, and small feature maps may be extracted from the encoder of the person detection model in step 2, and the feature stitching is performed to fuse the multi-scale image features to form the encoder of the portrait alpha mask matting network, to implement the encoder shared by the person detection and portrait alpha mask matting networks.

In step 3, forward access to the deep residual neural network constructed in step 2 may be performed to obtain outputs of the residual blocks res_block with downsampling multiples of 8 times, 16 times, and 32 times. The outputs separately pass through a 3×3 convolution kernel and a 1×1 convolution kernel. The outputs are stitched to form large, medium, and small fused image feature structures as the encoder of the portrait alpha mask matting network, to implement the encoder shared by the person detection and portrait alpha mask matting networks.

The encoder shared by the person detection and portrait alpha mask matting networks in step 3 may specifically include:

(3.1) Perform forward access to the fully convolutional deep residual neural network to obtain the outputs of the residual blocks res_block with the downsampling multiples of 8 times, 16 times, and 32 times. Convolution kernels with a stride of 2 are used to implement the downsampling. core₈, core₁₆, and core₃₂ are set as the convolution kernels during the downsampling, and a size of the convolution kernel is x,y. A size of an input input is m,n, and a size of an output output is m/2,n/2. Convolution corresponding to the output is expressed by formula (1). fun(⋅) represents an activation function, and β represents a bias.

output_{m/2,n/2}=fun(ΣΣinputₘₙ*core_{xy}+β) (1)

(3.2) Fuse and stitch the output to form large, medium, and small fused image feature structures as the encoder of the portrait alpha mask matting network, to implement the encoder shared by the person detection and portrait alpha mask matting networks.

In step 4, a main structure of the decoder includes upsampling, convolution, an exponential linear unit (ELU) activation function, and a fully connected layer for outputting. The image containing the person information and the trimap are input, the network loss function with an alpha mask prediction error and an image compositing error as a core is constructed, and the portrait alpha mask matting network is trained and optimized.

The upsampling is used to restore an image feature size after downsampling in the encoder. A scaled ELU (SELU) activation function is used. Hyperparameters λ and α in the SELU activation function are fixed constants. The activation function is expressed by formula (2):

$$SeLU ( x ) = λ \{ \begin{matrix}x , x > 0 \\ α ( {e}^{x} - 1 ) , x \leq 0\end{matrix} \qquad ( 2 )$$

In step 4, that the loss function of the portrait alpha mask matting network is constructed may specifically include:

(4.1) Compute an alpha mask prediction error, as expressed by formula (3):

Loss_{αlp}=\sqrt{(αₚᵣₑ−α_{gro})²}+ε,αₚᵣₑ,α_{gro}∈[0,1] (3)

where αₚᵣₑ and α_{gro} respectively represent predicted and ground-truth alpha mask values, and E represents a very small constant.

(4.2) Compute an image compositing error, as expressed by formula (4):

Loss_{com}=\sqrt{(cₚᵣₑ−c_{gro})²}+ε (4)

where cₚᵣₑ and c_{gro} respectively represent predicted and ground-truth alpha composite images, and E represents a very small constant.

(4.3) Construct an overall loss function based on the alpha mask prediction error and the image compositing error, as expressed by formula (5):

Lossₒᵥₑᵣₐₗₗ=ω₁Loss_{αlp}ω₂Loss_{com},ω₁+ω₂=1 (5)

In step 5, the preprocessed image data obtained in step 1 is input to the trained person detection network model, and the ROI of the portrait foreground and the portrait trimap in the ROI are predicted through the logistic regression.

The ROI of the portrait foreground is obtained by performing edge dilation on a general ROI for object detection. This prevents a fine edge of a person being placed outside the ROI during object detection. The portrait trimap in the ROI is obtained through erosion and dilation of the person binary classification cross-entropy error in the loss function in step 2.

In step 5, the outputting a ROI of portrait foreground and a portrait trimap in the ROI may specifically include:

(5.1) Use a relative intersection over union (RIOU) obtained by improving an original criterion for determining the ROI of the portrait foreground. This enables the ROI to have a stronger enclosing capability and prevents the fine edge of the person being placed outside the ROI during the object detection. The RIOU is expressed by formula (7):

$$RIOU = \frac{[ {ROI}_{p} ⋂ {ROI}_{g} ]}{[ {ROI}_{p ⋃} {ROI}_{g} + α ( {ROI}_{g} - {ROI}_{p} ⋂ {ROI}_{g} ) ]} - \frac{[ {ROI}_{edge} - {ROI}_{p} ⋂ {ROI}_{g} ]}{[ {ROI}_{edge} ]} \qquad ( 7 )$$

where ROI_{edge} represents a minimum bounding rectangle ROI that can enclose ROIₚ and ROI_{g}, [⋅] represents an area of the ROI, ROIₚ represents a predicted value of the ROI of the portrait foreground, and ROI_{g} represents a ground-truth value of the ROI of the portrait foreground.

(5.2) For person foreground and background binary classification results, use an erosion algorithm to remove noise, and then use a dilation algorithm to generate a clear edge contour. The finally obtained portrait trimap is expressed by formula (8):

$${trimap}_{i} = \{ \begin{matrix}1 {pixel}_{i} ∈ f ( {pixel}_{i} ) \\ 0.5 otherwise \\ 0 {pixel}_{i} ∈ b ( {pixel}_{i} )\end{matrix} \qquad ( 8 )$$

where f(pixelᵢ) indicates that the i^{th} pixel pixelᵢ belongs to the foreground, b(pixelᵢ) indicates that the i^{th} pixel pixelᵢ belongs to the background, trimapᵢ represents an alpha mask channel value of the i^{th} pixel pixelᵢ, and otherwise indicates that it cannot be determined whether the pixel belongs to the foreground or background.

In step 6, feature mapping is performed on the ROI of the original portrait foreground in step 5, and the portrait trimap in the ROI is input into the portrait alpha mask matting network model to reduce a convolution computing scale and accelerate network computing. After an original resolution of the image is restored through the upsampling of the decoder, a portrait alpha mask prediction result is obtained from the output of the fully connected layer. The portrait matting is completed.

In the present disclosure, the binary classification adjustment is performed on the original dataset, the image or video containing the portrait information is input, and preprocessed network input data is obtained through video frame processing and input image resizing; the deep learning network for person detection is constructed, the image features are extracted by using the deep residual neural network, and the ROI of the portrait foreground and the portrait trimap in the ROI are obtained through the logistic regression; and the portrait alpha mask matting deep learning network is constructed. An encoder sharing mechanism effectively accelerates a computing process of the network. The alpha mask prediction result of the portrait foreground is output in an end-to-end manner to implement the portrait matting. In this method, green screens are not required during the portrait matting. In addition, during the matting, only original images or videos need to be provided, without a need to provide manually annotated portrait trimaps. This provides great convenience for users. Finally, the encoder sharing mechanism proposed in the present disclosure accelerates task computing, implement real-time portrait matting while providing high-definition image quality, and meets user requirements in a plurality of scenarios.

Compared with the prior art, the present disclosure has the following advantages:

The present disclosure provides a multi-task deep learning-based real-time matting method for non-green-screen portraits. Focusing on the key technologies such as person detection, trimap generation, and portrait alpha mask matting during portrait matting in complex natural environments, the present disclosure implements requirement-free, real-time, and automatic portrait matting when professional green screen devices are lacked. The method in the present disclosure resolves limitations of traditional digital image matting technologies on devices and sites, and is applied to application programs such as network meetings and photography editing to provide real-time and convenient digital portrait matting services for general users. The innovation of the present disclosure is embodied in the following aspects:

(1) The present disclosure innovatively proposes the modification and supplement to the traditional COCO 80-class multi-object detection dataset, to form the unique person-others two-class dataset in the present disclosure. This significantly reduces difficulty in training sample construction and improves the accuracy of the subsequent person detection by the network model.

(2) The present disclosure innovatively proposes a RIOU for determining the ROI during the object detection. This enables the ROI to have a stronger enclosing capability and prevents a fine edge of a person being placed outside the ROI during the object detection.

(3) The present disclosure innovatively proposes the encoder sharing mechanism for the person detection network and portrait alpha mask matting network. This greatly reduces the time consumed by the algorithm during the image feature recognition, and implements high-definition real-time portrait matting.

### BRIEF DESCRIPTION OF THE DRAWINGS

FIG. 1 is a schematic diagram of a network structure of a multi-task deep learning-based real-time matting method for non-green-screen portraits according to the present disclosure;

FIG. 2 is a schematic diagram of a binary classification process of an original multi-class dataset according to the present disclosure;

FIG. 3 is a flowchart of person detection in an method according to the present disclosure;

FIG. 4 is a flowchart of portrait alpha mask matting in an method according to the present disclosure;

FIG. 5 is a flowchart of an inference process of an method according to the present disclosure; and

FIG. 6 is an overall flowchart of a method according to the present disclosure.

### DETAILED DESCRIPTION OF THE EMBODIMENTS

The following further describes a multi-task deep learning-based real-time matting method for non-green-screen portraits with reference to the accompanying drawings.

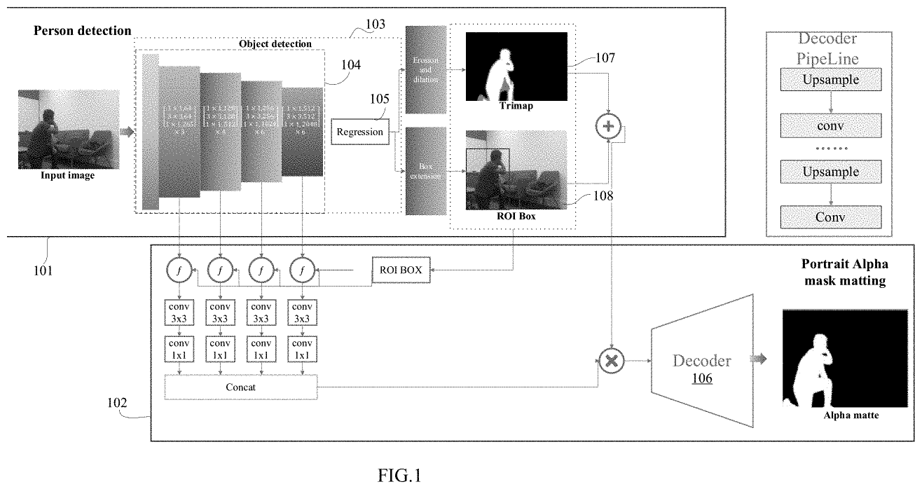

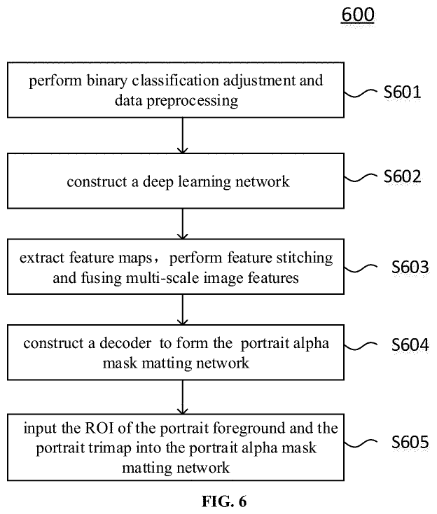

As shown in FIGS. 1 and 6, a multi-task deep learning-based real-time matting method 600 for non-green-screen portraits includes the following steps:

Step S601: Improve an original dataset, input an image or video in an improved dataset, and perform corresponding data preprocessing on the image or video to obtain preprocessed data of an original input file.

That the original dataset is improved and the data preprocessing is performed in step 1 may specifically include:

(1.1) Perform binary classification adjustment and supplement on a multi-class multi-object detection dataset. The binary classification adjustment is performed to modify an original 80-class COCO dataset to two classes: person and others, and supplement the dataset according to this criterion.

(1.2) Perform video frame processing by using FFmpeg to convert the video into video frames such that a processed video file can be processed by using a same method as that used to process an image file in subsequent work.

(1.3) Resize the input images by unifying sizes of different input images through cropping and padding and keep sizes of network feature maps the same as those of the original images.

Step S602: Use an encoder-logistic regression structure to construct a deep learning network 103 for person detection. Input the preprocessed data obtained in step 1, construct a loss function, and train and optimize the deep learning network for person detection to obtain a person detection model.

The deep learning network 103 for person detection may specifically include:

(2.1) The encoder 104 is a fully convolutional residual neural network. In the network, skip connections are used to construct residual blocks res_block of different depths, and a feature sequence is obtained by extracting features of the image containing the portrait information.

(2.2) The loss function is constructed by adding a cross-entropy error of the person-others binary classification as an additional load to a general object detection task.

(2.3) The logistic regression 105 is an output structure for multi-scale detection of a central position (xᵢ, yᵢ) of a ROI, a length and width (wᵢ, hᵢ) of the ROI, a confidence level Cᵢ of the ROI, and a class pᵢ(c), c E classes of an object in the ROI. classes represents all classes in the training sample, namely, [class0:person, class1:others], and pixelᵢ represents an i^{th} pixel in the ROI.

Step S603: Fuse multi-scale image features to form an encoder of a portrait alpha mask matting network, to implement an encoder shared by the person detection and portrait alpha mask matting networks.

The multi-scale encoder shared by the person detection and portrait alpha mask matting networks may specifically include:

(3.1) Perform forward access to the fully convolutional deep residual neural network 104 to obtain outputs of the residual blocks res_block with downsampling multiples of 8 times, 16 times, and 32 times. Convolution kernels with a stride of 2 are used to implement the downsampling. core₈, core₁₆, and core₃₂ are set as the convolution kernels during the downsampling, and a size of the convolution kernel is x,y. A size of an input input is m,n, and a size of an output output is m/2,n/2. Convolution corresponding to the output is expressed by formula (1). fun(⋅) represents an activation function, and β represents a bias.

output_{m/2,n/2}=fun(ΣΣinputₘₙ*core_{xy}+β) (1)

(3.2) Fuse and stitch the output to form large, medium, and small fused image feature structures as the encoder of the portrait alpha mask matting network, to implement the encoder shared by the person detection and portrait alpha mask matting networks.

Step S604: Construct a decoder 106 of the portrait alpha mask matting network, and form an end-to-end encoder-decoder portrait alpha mask matting network structure together with the shared encoder in step 3. Input an image containing person information and a trimap 107, construct a loss function, and train and optimize the portrait alpha mask matting network.

A main structure of the decoder 106 of the portrait alpha mask matting network may include upsampling, convolution, an ELU activation function, and a fully connected layer for outputting.

(4.1) The upsampling is implemented by an upsampling operation to restore an image feature size after downsampling in the encoder.

(4.2) A SELU activation function is used to set outputs of some neurons in the deep learning network to 0 to form a sparse network structure. Hyperparameters λ and α in the SELU activation function are fixed constants, and the activation function is expressed by formula (2):

$$SeLU ( x ) = λ \{ \begin{matrix}x , x > 0 \\ α ( {e}^{x} - 1 ) , x \leq 0\end{matrix} \qquad ( 2 )$$

That the loss function of the portrait alpha mask matting network is constructed may specifically include:

(4.3) An alpha mask prediction error is expressed by formula (3):

Loss_{αlp}=\sqrt{(αₚᵣₑ−α_{gro})²}+ε,αₚᵣₑ,α_{gro}∈[0,1] (3)

where αₚᵣₑ and α_{gro} respectively represent predicted and ground-truth alpha mask values, and E represents a very small constant.

(4.4) An image compositing error is expressed by formula (4):

Loss_{com}=\sqrt{(cₚᵣₑ−c_{gro})²}+ε (4)

where cₚᵣₑ and c_{gro} respectively represent predicted and ground-truth alpha composite images.

(4.5) An overall loss function is constructed based on the alpha mask prediction error and the image compositing error, as expressed by formula (5):

Lossₒᵥₑᵣₐₗₗ=ω₁Loss_{αlp}ω₂Loss_{com},ω₁+ω₂=1 (5)

Step S605: Input the preprocessed image data obtained in step 1 to a trained network, and output a ROI 108 of portrait foreground and a portrait trimap 107 in the ROI 108 through the logistic regression of the person detection network in step 2.

That the ROI 108 of the portrait foreground and the portrait trimap 107 in the ROI 108 are output may specifically include:

(5.1) Use a RIOU obtained by improving an original criterion for determining the ROI of the portrait foreground. This enables the ROI to have a stronger enclosing capability and prevents a fine edge of a person being placed outside the ROI during object detection. The RIOU is expressed by formula (7):

$$RIOU = \frac{[ {ROI}_{p} ⋂ {ROI}_{g} ]}{[ {ROI}_{p ⋃} {ROI}_{g} + α ( {ROI}_{g} - {ROI}_{p} ⋂ {ROI}_{g} ) ]} - \frac{[ {ROI}_{edge} - {ROI}_{p} ⋂ {ROI}_{g} ]}{[ {ROI}_{edge} ]} \qquad ( 7 )$$

where ROI_{edge} represents a minimum bounding rectangle ROI that can enclose ROIₚ and ROI_{g}, and [⋅] represents an area of the ROI.

(5.2) For person foreground and background binary classification results, use an erosion algorithm to remove noise, and then use a dilation algorithm to generate a clear edge contour. The finally obtained portrait trimap 107 is expressed by formula (8):

$${trimap}_{i} = \{ \begin{matrix}1 {pixel}_{i} ∈ f ( {pixel}_{i} ) \\ 0.5 otherwise \\ 0 {pixel}_{i} ∈ b ( {pixel}_{i} )\end{matrix} \qquad ( 8 )$$

where f(pixelᵢ) indicates that an i^{th} pixel pixelᵢ belongs to the foreground, b(pixelᵢ) indicates that the i^{th} pixel pixelᵢ belongs to the background, and trimapᵢ represents an alpha mask channel value of the i^{th} pixel pixelᵢ.

Step S606: Input the ROI 108 of the portrait foreground and the portrait trimap 107 in step 5 into the portrait alpha mask matting network constructed in step 4 to obtain a portrait alpha mask prediction result.

More specifically, the multi-task deep learning-based real-time matting method for non-green-screen portraits divides portrait matting into two parts of algorithm tasks: the person detection task 101 in step 1 and the portrait foreground alpha mask matting task 102 in step 2, specifically including the following steps:

In step 1, the data preprocessing includes video frame processing and input image resizing.

The video frame processing may include:

Convert the video into frames by using FFmpeg, use an original video number as a folder name in a project directory, and store the frames as image files in the folder. In this way, a processed video file can be processed by using a same method as that used to process an image file in subsequent work.

The input image resizing may include:

Unify sizes of different input images. Calculate a zoom factor with a longest side of an original image as a reference side, compress the longest side in equal proportions to an input criterion specified by the subsequent network, and fill vacant content on a short side with gray background through padding. Keep a size of a network feature map the same as that of the original image. This prevents abnormal network output values caused by an invalid size of the input image.

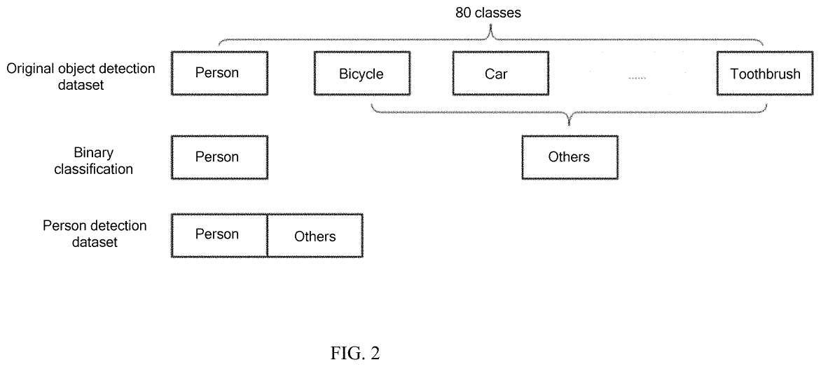

As shown in FIG. 2, the binary classification adjustment is performed to modify the original 80-class COCO dataset to two classes: person and others, and the dataset is supplemented according to this criterion. A task of detecting other classes of objects is abandoned to improve accuracy of subsequent person detection by the network model.

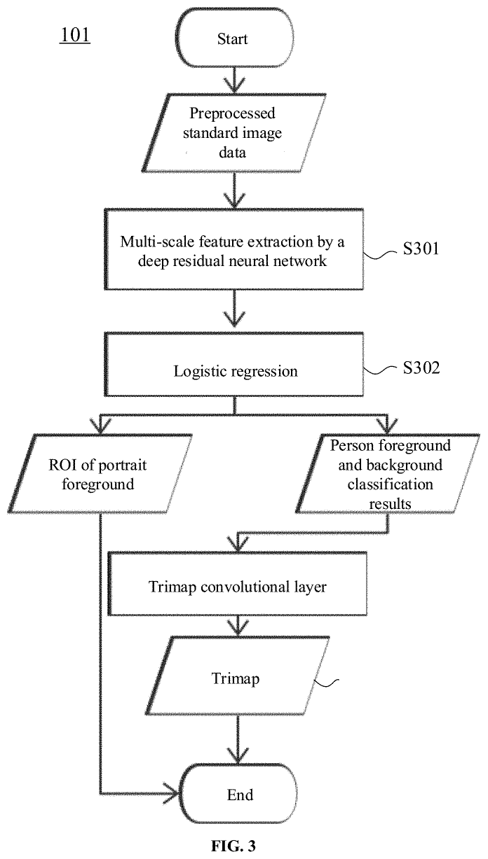

As shown in FIG. 3, the deep learning network 103 for person detection in the first part of the entire network is implemented through model prediction of the deep residual neural network. The deep residual neural network 103 includes an encoder 104 and logistic regression 105.

Step S301: The encoder 104 is a fully convolutional residual neural network. In the network 104, skip connections are used to construct residual blocks res_block of different depths, and a feature sequence x is obtained by extracting features of the image containing the portrait information. For a processed frame {Vₜ}ₜ₌₁^{T}, a feature sequence {xₜ}ₜ₌₁^{T} of a length T is extracted. Vₜ represents a t^{th} frame, and xₜ represents a feature sequence of the t^{th} frame.

The feature extraction may include:

Use a deep learning technology to perform a cognitive process of the original image or the frame obtained after the video is preprocessed, and convert the image into a feature sequence that can be recognized by a computer.

Step S302: The logistic regression 105 is an output structure for multi-scale detection of a central position (xᵢ, yᵢ) of a ROI, a length and width (wᵢ, hᵢ) of the ROI, a confidence level Cᵢ of the ROI, a class pᵢ(c), c∈classes of an object in the ROI, and the person foreground f(pixelᵢ) and background b(pixelᵢ) binary classification results. classes represents all classes in the training sample, namely, [class0:person, class1:others], and pixelᵢ represents the i^{th} pixel in the ROI.

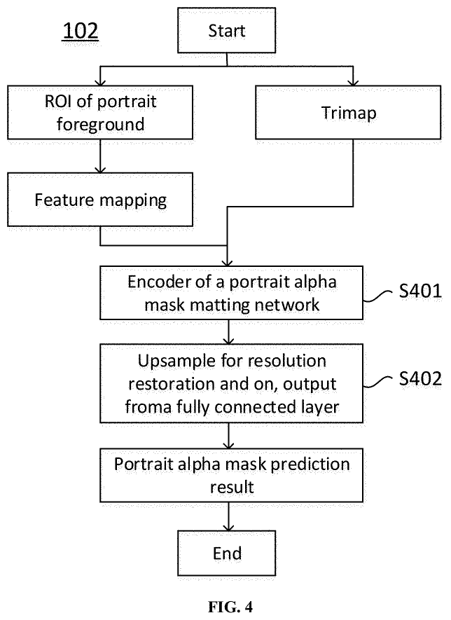

As shown in FIG. 4, the portrait alpha mask matting network in the second part 102 of the entire network includes the shared encoder 106 and the portrait alpha mask matting decoder, specifically including the following implementation:

Step S401: Perform forward access to the deep residual neural network to obtain the outputs of the residual blocks res_block with downsampling multiples of 8 times, 16 times, and 32 times. To reduce a negative effect of a gradient caused by pooling, the downsampling adopts convolution kernels with a stride of 2. core₈, core₁₆, and core₃₂ are set as the convolution kernels during the downsampling. Quantities of channels channel_n are equal to corresponding inputs input₈, input₁₆, and input₃₂, and a size of the convolution kernel is x,y. A size of an input input is m,n, and a size of an output output is m/2,n/2. Convolution corresponding to the output is expressed by formula (1). fun(⋅) represents an activation function, and β represents a bias.

output_{m/2,n/2}=fun(ΣΣinputₘₙ*core_{xy}+β) (1)

Further, corresponding outputs pass through a 3×3 convolution kernel conv3 to expand a receptive field of the feature map and increase local context information of the image feature. Then, the outputs pass through a 1×1 convolution kernel conv1 to reduce a feature channel dimension. The outputs are fused and stitched to form large, medium, and small fused image feature structures as the encoder of the portrait alpha mask matting network, to implement the encoder shared by the person detection and portrait alpha mask matting networks.

Step S402: A main structure of the decoder includes upsampling, convolution, an ELU activation function, and a fully connected layer for outputting. Input the image containing the person information and the trimap, construct a network loss function with an alpha mask prediction error and an image compositing error as a core, and train and optimize the portrait alpha mask matting network.

The upsampling is implemented by an upsampling operation. A specific value in the input image feature is mapped and filled to a corresponding area of the output upsampled image feature, and a blank area after upsampling is filled with the same value to restore the size of the image feature after downsampling in the encoder.

A SELU activation function is used to set outputs of some neurons in the deep learning network to 0 to form a sparse network structure. This effectively reduces overfitting of the matting network, and avoids gradient disappearance of a traditional sigmoid activation function during back propagation. Hyperparameters λ and α in the SELU activation function are fixed constants, and the activation function is expressed by formula (2):

$$SeLU ( x ) = λ \{ \begin{matrix}x , x > 0 \\ α ( {e}^{x} - 1 ) , x \leq 0\end{matrix} \qquad ( 2 )$$

The alpha mask prediction error is expressed by formula (3):

Loss_{αlp}=\sqrt{(αₚᵣₑ−α_{gro})²}+ε,αₚᵣₑ,α_{gro}∈[0,1] (3)

where αₚᵣₑ and α_{gro} respectively represent predicted and ground-truth alpha mask values, and ε represents a very small constant.

The image compositing error is expressed by formula (4):

Loss_{com}=\sqrt{(cₚᵣₑ−c_{gro})²}ε (4)

where cₚᵣₑ and c_{gro} respectively represent predicted and ground-truth alpha composite images, and ε represents a very small constant.

An overall loss function is constructed based on the alpha mask prediction error and the image compositing error, as expressed by formula (5):

Lossₒᵥₑᵣₐₗₗ=ω₁Loss_{αlp}ω₂Loss_{com},ω₁+ω₂=1 (5)

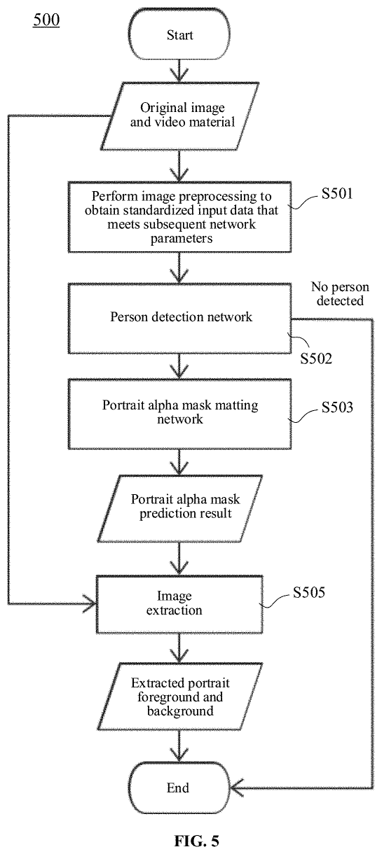

As shown in FIG. 5, after the algorithm provided in the present disclosure is trained, a real-time portrait matting inference process 500 can be carried out.

Step S501: The improvement and the data preprocessing is performed on dataset to be processed.

Step S502: Input preprocessed image data to the trained person detection network model, and predict a ROI of portrait foreground and a portrait trimap 107 in the ROI through the logistic regression.

Generally, a ROI is determined based on an IOU during object detection, as expressed by formula (6). ROIₚ and ROI₉ respectively represent predicted and ground-truth ROIs.

$$IOU = \frac{[ {ROI}_{p} ⋂ {ROI}_{g} ]}{[ {ROI}_{p ⋃} {ROI}_{g} ]} \qquad ( 6 )$$

The present disclosure proposes the RIOU for determining the ROI of the portrait foreground. This enables the ROI to have a stronger enclosing capability and prevents a fine edge of a person being placed outside the ROI during object detection. The RIOU is expressed by formula (7):

$$RIOU = \frac{[ {ROI}_{p} ⋂ {ROI}_{g} ]}{[ {ROI}_{p ⋃} {ROI}_{g} + α ( {ROI}_{g} - {ROI}_{p} ⋂ {ROI}_{g} ) ]} - \frac{[ {ROI}_{edge} - {ROI}_{p} ⋂ {ROI}_{g} ]}{[ {ROI}_{edge} ]} \qquad ( 7 )$$

where ROI_{edge} represents a minimum bounding rectangle ROI that can enclose ROIₚ and ROI_{g}, and [⋅] represents an area of the ROI.

Further, for person foreground and background binary classification results, use an erosion algorithm to remove noise, and then use a dilation algorithm to generate a clear edge contour. The finally obtained portrait trimap 107 is expressed by formula (8):

$${trimap}_{i} = \{ \begin{matrix}1 {pixel}_{i} ∈ f ( {pixel}_{i} ) \\ 0.5 otherwise \\ 0 {pixel}_{i} ∈ b ( {pixel}_{i} )\end{matrix} \qquad ( 8 )$$

where f(pixelᵢ) indicates that an i^{th} pixel pixelᵢ belongs to the foreground, b(pixelᵢ) indicates that the i^{th} pixel pixelᵢ belongs to the background, and trimapᵢ represents an alpha mask channel value of the i^{th} pixel pixelᵢ.

Step S503: Perform feature mapping on the ROI 108 of the original portrait foreground in step 2, and input the portrait trimap 107 in the ROI 108 into the portrait alpha mask matting network model to reduce a convolution computing scale and accelerate network computing. After an original resolution of the image is restored through the upsampling of the decoder, a portrait alpha mask prediction result a is obtained from the output of the fully connected layer.

Step S504; In combination with the original input image, the portrait matting task is completed through foreground extraction, as expressed by formula (9). I represents the input image, F represents the portrait foreground, and B represents the background image.

I=αF+(1−α)B (9)

The foregoing is merely a description of the embodiments of the present disclosure, and is not a limitation to the present disclosure. Those of ordinary skill in the art should realize that any changes and modifications made to the present disclosure fall within the protection scope of the present disclosure.

What is claimed is:

1. A multi-task deep learning-based real-time matting method for non-green-screen portraits, comprising:
step 1: performing binary classification adjustment on an original multi-class multi-object detection dataset, inputting an image or video containing portrait information, and performing data preprocessing on the image or video to obtain preprocessed data of an original input file;
step 2: using an encoder-logistic regression structure to construct a deep learning network for person detection, inputting the preprocessed data obtained in step 1, constructing a loss function, training and optimizing the deep learning network for person detection to obtain a person detection model;
step 3: extracting feature maps from an encoder of the person detection model in step 2, and performing feature stitching and fusing multi-scale image features to form an encoder of a portrait alpha mask matting network, to implement an encoder shared by the person detection and portrait alpha mask matting networks;
step 4: constructing a decoder of the portrait alpha mask matting network, forming an end-to-end encoder-decoder portrait alpha mask matting network structure together with the shared encoder in step 3, inputting an image containing person information and a trimap, constructing a loss function, and training and optimizing the portrait alpha mask matting network;
step 5: inputting the preprocessed data obtained in step 1 to a trained network in step 4, and outputting a region of interest (ROI) of portrait foreground and a portrait trimap in the ROI through logistic regression of the person detection model in step 2; and
step 6: inputting the ROI of the portrait foreground and the portrait trimap in step 5 into the portrait alpha mask matting network constructed in step 4 to obtain a portrait alpha mask prediction result.

2. The multi-task deep learning-based real-time matting method for non-green-screen portraits according to claim 1, wherein the data preprocessing in step 1 comprises video frame processing and input image resizing.

3. The multi-task deep learning-based real-time matting method for non-green-screen portraits according to claim 1, wherein the deep learning network for person detection in step 2 is implemented through model prediction of a deep residual neural network.

4. The multi-task deep learning-based real-time matting method for non-green-screen portraits according to claim 1, wherein a main structure of the decoder in step 4 comprises upsampling, convolution, an exponential linear unit (ELU) activation function, and a fully connected layer for outputting.

5. The multi-task deep learning-based real-time matting method for non-green-screen portraits according to claim 4, wherein the upsampling is used to restore an image feature size after downsampling in the encoder, a scaled ELU (SELU) activation function is used, hyperparameters λ and α are fixed constants, and the activation function is expressed by formula (2):
$$SeLU ( x ) = λ \{ \begin{matrix}x , x > 0 \\ α ( {e}^{x} - 1 ) , x \leq 0\end{matrix} . \qquad ( 2 )$$

6. The multi-task deep learning-based real-time matting method for non-green-screen portraits according to claim 1, wherein the constructing a loss function, and training and optimizing the portrait alpha mask matting network in step 4 specifically comprise:
(4.1) computing an alpha mask prediction error, as expressed by formula (3):
Loss_{αlp}=\sqrt{(αₚᵣₑ−α_{gro})²}+ε,αₚᵣₑ,α_{gro}∈[0,1] (3)
wherein Loss_{αlp} represents the alpha mask prediction error, αₚᵣₑ and α_{gro} respectively represent predicted and ground-truth alpha mask values, and ε represents a very small constant;
(4.2) computing an image compositing error, as expressed by formula (4):
Loss_{com}=\sqrt{(cₚᵣₑ−c_{gro})²}+ε (4)
wherein Loss_{com} represents the image compositing error, cₚᵣₑ and c_{gro} respectively represent predicted and ground-truth alpha composite images, and ε represents a very small constant; and
(4.3) constructing an overall loss function based on the alpha mask prediction error and the image compositing error, as expressed by formula (5):
Lossₒᵥₑᵣₐₗₗ=ω₁Loss_{αlp}+ω₂Loss_{com},ω₁+ω₂=1 (5)
wherein Lossₒᵥₑᵣₐₗₗ represents the overall loss function, ω₁ and ω₂ respectively represent weights of the alpha mask prediction error Loss_{αlp} and the image compositing error Loss_{αlp}.

7. The multi-task deep learning-based real-time matting method for non-green-screen portraits according to claim 1, wherein the outputting a ROI of portrait foreground and a portrait trimap in the ROI in step 5 specifically comprise:
(5.1) using a relative intersection over union (RIOU) obtained by improving an original criteria for determining the ROI of the portrait foreground, wherein the RIOU is expressed by formula (7):
$$RIOU = \frac{[ {ROI}_{p} ⋂ {ROI}_{g} ]}{[ {ROI}_{p ⋃} {ROI}_{g} + α ( {ROI}_{g} - {ROI}_{p} ⋂ {ROI}_{g} ) ]} - \frac{[ {ROI}_{edge} - {ROI}_{p} ⋂ {ROI}_{g} ]}{[ {ROI}_{edge} ]} \qquad ( 7 )$$
wherein ROI_{edge} represents a minimum bounding rectangle ROI that can enclose ROIₚ and ROI_{g}, [⋅] represents an area of the ROI, ROIₚ represents a predicted value of the ROI of the portrait foreground, and ROI_{g} represents a ground-truth value of the ROI of the portrait foreground; and
(5.2) for person foreground and background binary classification results, using an erosion method to remove noise, and then using a dilation method to generate a clear edge contour, to obtain the portrait trimap, as expressed by formula (8):
$${trimap}_{i} = \{ \begin{matrix}1 {pixel}_{i} ∈ f ( {pixel}_{i} ) \\ 0.5 otherwise \\ 0 {pixel}_{i} ∈ b ( {pixel}_{i} )\end{matrix} \qquad ( 8 )$$
wherein f(pixelᵢ) indicates that an i^{th} pixel pixelᵢ belongs to the foreground, b(pixelᵢ) indicates that the i^{th} pixel pixelᵢ belongs to the background, otherwise indicates that it cannot be determined whether the pixel belongs to the foreground or background, and trimapᵢ represents an alpha mask channel value of the i^{th} pixel pixelᵢ.

8. A multi-task deep learning-based real-time matting system for non-green-screen portraits, comprising an input unit, a processor and a memory storing program codes, wherein the processor performs the stored program codes for:
step 1: performing binary classification adjustment on an original multi-class multi-object detection dataset, and performing data preprocessing on an image or video containing portrait information and inputted from the input unit, to obtain preprocessed data of an original input file;
step 2: using an encoder-logistic regression structure to construct a deep learning network for person detection, inputting the preprocessed data obtained in step 1, constructing a loss function, training and optimizing the deep learning network for person detection to obtain a person detection model;
step 3: extracting feature maps from an encoder of the person detection model in step 2, and performing feature stitching and fusing multi-scale image features to form an encoder of a portrait alpha mask matting network, to implement an encoder shared by the person detection and portrait alpha mask matting networks;
step 4: constructing a decoder of the portrait alpha mask matting network, forming an end-to-end encoder-decoder portrait alpha mask matting network structure together with the shared encoder in step 3, inputting an image containing person information and a trimap, constructing a loss function, and training and optimizing the portrait alpha mask matting network;
step 5: inputting the preprocessed data obtained in step 1 to a trained network in step 4, and outputting a region of interest (ROI) of portrait foreground and a portrait trimap in the ROI through logistic regression of the person detection model in step 2; and
step 6: inputting the ROI of the portrait foreground and the portrait trimap in step 5 into the portrait alpha mask matting network constructed in step 4 to obtain a portrait alpha mask prediction result.

9. A computer program product comprising a non-volatile computer readable medium having computer executable codes stored thereon, the codes comprising instructions for:
step 1: performing binary classification adjustment on an original multi-class multi-object detection dataset, and performing data preprocessing on an image or video containing portrait information and inputted from the input unit, to obtain preprocessed data of an original input file;
step 2: using an encoder-logistic regression structure to construct a deep learning network for person detection, inputting the preprocessed data obtained in step 1, constructing a loss function, training and optimizing the deep learning network for person detection to obtain a person detection model;
step 3: extracting feature maps from an encoder of the person detection model in step 2, and performing feature stitching and fusing multi-scale image features to form an encoder of a portrait alpha mask matting network, to implement an encoder shared by the person detection and portrait alpha mask matting networks;
step 4: constructing a decoder of the portrait alpha mask matting network, forming an end-to-end encoder-decoder portrait alpha mask matting network structure together with the shared encoder in step 3, inputting an image containing person information and a trimap, constructing a loss function, and training and optimizing the portrait alpha mask matting network;
step 5: inputting the preprocessed data obtained in step 1 to a trained network in step 4, and outputting a region of interest (ROI) of portrait foreground and a portrait trimap in the ROI through logistic regression of the person detection model in step 2; and
step 6: inputting the ROI of the portrait foreground and the portrait trimap in step 5 into the portrait alpha mask matting network constructed in step 4 to obtain a portrait alpha mask prediction result.
